(19) United States
(12) Patent Application Publication
(10) Pub. No.: US 2012/0161353 A1
(43) Pub. Date: Jun. 28, 2012

(54) METHOD FOR PRODUCING SOUND-ABSORBING FLEXIBLE MOULDED FOAMS

(75) Inventors: Frithjof Hannig, Dusseldorf (DE); Thomas Gross, Wermelskirchen (DE); Stephan Schleiermacher, Pulheim (DE); Hans-Guido Wirtz, Leverkusen (DE); Heike Niederelz, Leverkusen (DE); Roger Scholz, Doenrade (NL)

(73) Assignee: BAYER MATERIAL SCIENCE AG, Leverkusen (DE)

(21) Appl. No.: 13/392,430

(22) PCT Filed: Aug. 13, 2010
(86) PCT No.: PCT/EP2010/004965

§ 371 Date: Mar. 14, 2012

(30) Foreign Application Priority Data
Aug. 26, 2009 (DE) 10 2009 038 886.9

(51) Int. Cl. B29C 44/08

(52) U.S. Cl. 264/45.3

(57) ABSTRACT

The invention relates to a method for producing sound-absorbing flexible polyurethane foam mouldings.

### PRIORITY

Priority is claimed as a national stage application, under 35 U.S.C. §371, to PCT/EP2010/004965 filed Aug. 13 2010, which claims priority to German Application No. 10 2009 038 886.9, filed Aug. 26, 2009. The disclosures of the aforementioned priority, applications are incorporated herein by reference in their entirety.

### BACKGROUND

The invention relates to a method for producing sound-absorbing flexible polyurethane foam moldings.

Molded flexible polyurethane foams are used in the sound absorption sector as well as elsewhere. The open-cell nature of the foams reduces airborne sound by absorption. It is prior art to combine such a foam, also called spring in this context, with a heavier material, also called mass in this context, in order to reduce structureborne sound as well as airborne sound. Optimum sound absorption is obtained on combining a very dense and thin mass layer with a very thick spring layer.

DE 10 2004 054 646 fabricates a mass and a spring from two polyurethanes which do not differ in the underlying polyether formulation and the isocyanate but only in the mixing ratio thereof. The mass utilizes a lower polyol content than the spring and the polyol in the mass is additionally admixed with high-gravity solids. The method is disadvantageous because three mold halves are needed in the production instead of two. To form the mass, the foaming, filled polyurethane system is compressed by two mold halves (A) and (B) such that there is no or scarcely any room for expansion and therefore the polyurethane reacts to form a compact layer. The disadvantage is that elevated clamping forces are required. Replacing the mold half (B) by a mold half (C) creates a new cavity which is bounded by the compact layer on the side of mold half (A) and by the mold half (C) itself on the opposite side. The cavity is filled with the polyurethane system such that it can expand into remaining free volume of the cavity and produce a foam.

M. Taverna (“Hochgefüllte PU-Formulierungen—Innovative Technologie für Stirnwände” PU Magazin June/July 2009 volume 09) reports a method wherein the filler is dispersed in the polyol, mixed with the isocyanate in a mixing head and discharged as a spray to produce the mass. The spring is produced as described above in a coupled reaction injection molding process (RIM process). The disadvantage is that machine parts which come into contact with the filled polyol wear quickly and therefore have to be protected against abrasion. Furthermore, the raw materials have to be strongly heated to lower the viscosity, with the disadvantages that the technical requirements for raw material heating are increased and raw materials are subjected to a high thermal load in the day containers of the metering machine. A further disadvantage is that this process requires two polyurethane systems to produce a compact mass and a foamed spray. Nor is it possible to change the filler content in the spray area in accordance with local requirements, since the polyol and the filler are present in a dispersed form in a fixed mixing ratio. Only varying the mixing ratio between the polyol and the isocyanate is possible, but would lead to locally varying mechanical properties for the matrix in the sprayed mass layer.

DE-A 101 61 600 and DE-A 10 2004 039 438 describe a method wherein a mass layer is sprayed onto a three-dimensionally molded surface. The polyol and the isocyanate are mixed together and then sprayed. Outside the spray head, the high-gravity solid, which is preferably barium sulfate, is metered into the free jet. The disadvantage of this method is that it either requires two different polyurethane systems to produce one compact mass layer and one spring layer, or fabrication steps with three instead of with two mold halves, as already explained above in connection with DE-A 10 2004 054 646.

Furthermore, according to the concept of DE-A 101 61 600, the wetting of fillers is incomplete when the filler is metered in high quantities into the spray jet outside the mixing head. At high proportions of filler, many particles of filler end up in the slipstream of other particles of filler, so that they become only insufficiently wetted by droplets of the polyurethane reaction mixture, if at all. Wetting is further incomplete because the wetting process in the spray jet is scarcely furthered by turbulence. It is true that colliding droplets of the spray jet and of the filler particles assume altered resulting flight paths in accordance with the laws of momentum, and can trigger slight turbulence by collision with neighboring particles in still unchanged flight paths, but the nature of the widening spray jet rapidly reduces the probability of such collisions, since all neighboring particles move away from each other, relatively speaking, in the conically spreading spray jet. As a result, turbulence decreases very rapidly, so that particle wetting remains inadequate in the final analysis. DE-A 10 2004 039 438 additionally mentions the idea of metering fillers into the mixing head. However, there is no further explanation as to how this is to be done.

The problem addressed by the present invention is that of providing a sound-insulating and also sound-dampening cladding requiring only two mold halves for its production and needing only one polyurethane system, which consists of a polyol formulation and an isocyanate formulation, so that the capital costs for molds can be kept low, storage space for liquids is saved and the logistics of liquid raw materials are simplified.

The problem is solved according to the invention when a solid substance (A) of high density optionally together with a second substance (B) and/or a third substance (C) is mixed in a mixing head with an isocyanate component (E) and a polyol component (D) and this mixture is sprayed onto a mold half 1 to form a mass layer. The substances (B) and (C) reduce and stop respectively the foaming up of the reacting polyurethane reactive mixture. This makes it possible to save a mold half which otherwise, through formation of an appropriately small cavity and through development of high locking forces on the part of the mold carrier, stops the polyurethane from foaming up. In a second step, the isocyanate component (E) and the polyol component (D) are mixed without the substances (A), (B) and (C) to produce the spring layer, for which more isocyanate is used relative to polyol than in the production of the mass layer. The polyurethane foams out the cavity between the mass layer and a mold half 2.

The invention provides a method for producing a molded flexible polyurethane foam comprising a layer of massive polyurethane comprising solid particles and a second layer of foamed polyurethane, which method is characterized in that
a) a gas stream containing solid particles is introduced into a liquid jet of a polyurethane reactive mixture in a mixing chamber (e.g. a spraying-mixing nozzle of the chamber),
b) the spray jet from a), which contains solid particles, is sprayed into a first mold half of an open mold comprising two mold halves,
c) the open mold is closed by means of a second mold half,
d) after full reaction of the polyurethane reactive mixture a second liquid spray jet of the polyurethane reactive mixture is injected into the closed mold without solid particles and therefore onto the fully reacted layer,
e) after full reaction of the second polyurethane reactive mixture the mold is opened and the molding is removed from the mold.

Suitable fillers (A) are preferably substances having a density above 2000 kg/m³, preferably above 3000 kg/m³ and more preferably above 4000 kg/m³. Suitable materials in addition to metal powders include hematite, ilmenite, cassiterite, molybdenite, scheelite, wolframite, sand, chrome ore sand waste (from foundries), olivine, chrome ore sand, chromite, zirconium silicate and zinc blende and also especially magnetite, fluor spar, barite and barium sulfate.

The filler (A) preferably contains particles having a diameter of 4 μm to 5 mm. In a preferred embodiment, the filler (A) contains no finely granular particles below 40 μm in diameter and only particles up to a diameter of 2 mm. Particular preference is given to particles having a diameter of 100 μm to 1000 μm. The latter fillers are obtainable for example as sieved fraction from commercially available solid substances.

The substance (B) is a drier which is used to form the mass layer. It withdraws water from the freshly mixed liquid isocyanate component (E) and the polyol component (D), and prevents the foaming reaction, since the water of the two liquid components of the reaction mixture is withdrawn.

The mass layer comprises, viewed relatively, a larger amount of polyol being reacted with a specified amount of isocyanate than is reacted in the spring layer with the same amount of isocyanate. The assumption for the mass layer is that the water has been partially or completely removed by the drier. The withdrawal of water causes the OH number of the polyol formulation to decrease. Given a constant isocyanate index, the polyol formulation needs less isocyanate to achieve the same percentage conversion as in the spring layer. The isocyanate index is the ratio of deployed isocyanate quantity and stoichiometrically needed isocyanate quantity for quantitative reaction with the polyol formulation multiplied by a factor of 100.

In a preferred embodiment, the isocyanate index I_{F} of the spring layer (F) and the isocyanate index I_{M} of the mass layer (M) are each set between 70 to 130. Preferably, the isocyanate index I_{M} for the mass layer (M) is equal to the isocyanate index I_{F} of the spring layer (F):

I_{M}=I_{F}

The isocyanate index I_{M} of the mass layer (M) can also have a value which is closer to 100 than the isocyanate index I_{F} of the spring layer (F):

|100−I_{F}|≧|100−I_{M}|

Table 1 in the Examples part shows various quantitative ratios in which the liquid isocyanate component (E) and the polyol component (D) are mixed to produce the spring and mass layers respectively, while the isocyanate index is 100 for both the layers.

Substance (B) is suitably a drier such as, for example, silica gel, calcined argillaceous earth, calcium chloride, calcium oxide, magnesium chloride, magnesium sulfate, magnesium oxide, sodium sulfate, potassium carbonate, copper sulfate, barium oxide, drying clay, aluminosilicates, especially molecular sieves based on zeolite such as, for example, UOP® powder, also known under the synonym of Baylith® produced by UOP M.S. S.r.l., alumina, superabsorbents such as, for example, potassium hydroxide neutralized polyacrylic acid, bentonite, montmorillonite and mixtures thereof. Particular preference is given to zeolite-based molecular sieves. The amount of drier (B) is preferably in the range from 0.5% to 50% by weight, based on the polyurethane reactive mixture, more preferably in the range from 2 to 40 weight percent and even more preferably in the range from 10 to 30 weight percent.

The substance (C) can be a defoaming agent with which the substance (B) and/or the substance (A) can be wetted up to preferably 1 weight percent for example. However, the substance (C) can also be metered into the mixing head feed line of isocyanate component (E) or of polyol component (D) via a calibration block for example. With this method, however, there is a risk that, on switching from shot operation to circulation, some of the substance (C) will pass via the mixing head return lines into the day containers, so that it will no longer be possible to produce a foamed spring layer with the raw materials. Therefore, metering into the mixing head is preferable. When metering into feed lines or into the mixing head, amounts of 0.1 up to 25 weight percent, based on the total amount of polyol component (D) and isocyanate component (E), are preferred, amounts of 1 up to 20 weight percent are particularly preferred and amounts of 5 up to 15 weight percent are very particularly preferred.

As substance (C) there come into consideration substances which either displace surface-active foam-formers from the interface without themselves producing foam, or which reduce the surface tension between the gas, the filler particles and the polyurethane reaction mixture. This includes natural fats and oils, aromatic and aliphatic mineral oils, polybutadienes, fatty alcohols, long-chain soaps, for example sodium behenate (sodium salt of docosanoic acid), poly(ethylene/propylene) glycol ethers, for example Pluronic® products, and also mixed ethers or endcapped (usually etherified) alkyl polyethylene glycol ethers and especially silicone-based defoamers, for example polydimethylsiloxanes and also otherwise organically modified/functionalized polysiloxanes.

Components (D) and (E) for producing the molded flexible polyurethane foam of the spring layer (F) and the mass layer (M) are well-known polyol components and isocyanate components from the prior art. With regard to the polyol component, it has proved possible to replace some of the polyol by renewable raw materials, for example castor oil or other known vegetable oils, their chemical reaction products or derivatives. Such a replacement is not associated with any deterioration in the properties of the final molded flexible polyurethane foam body and is advantageous in that such foam bodies make an appreciable contribution to sustainableness. Besides, in addition to the known polyols (e.g., polyester polyols, polyether polyols, polycarbonate diols, polyetherester polyols) and also chain extenders and/or crosslinking agents, the polyol component may further comprise conventional auxiliary and addition agents, for example catalysts, activators, stabilizers. The isocyanate component may be an organic isocyanate, a modified isocyanate or a prepolymer.

The one or more gas streams containing solid material are introduced, not into the already dispersed spray jet of the reaction mixture, but into the still liquid undispersed jet in the mixing chamber. Here there is still an essentially laminar flow of the reaction mixture.

A “liquid jet of a PUR reaction mixture” for the purposes of the invention refers to such a fluid jet of a PUR material, especially in the region of a mixing chamber to mix the reaction components in liquid form, as is not yet in the form of fine reaction mixture droplets dispersed in a gas stream, i.e. especially in a liquid viscous phase.

While the processes of the prior art essentially use a gas stream or a corresponding nozzle to atomize a PUR reaction mixture and a solids-containing gas stream is blown into such an atomized PUR spray jet, the process of the present invention is characterized in that it utilizes a solids-containing gas stream in a spray-mixing nozzle to atomize a liquid jet of a PUR reaction mixture on exit from the mixing chamber. It is true for this spray jet like every other spray jet that the separation between adjacent particles in the spray in a direction orthogonal to the main spray direction of a spray jet increases with increasing distance from the spray nozzle. This necessarily causes a rapid decrease in the probability that solid particles will collide with polyurethane droplets or already wetted filler particles and become wetted in this way. Circumstances change when, in accordance with the process of the present invention, the mixing of fillers and polyurethane takes place in a mixing chamber.

The process of the present invention is characterized in that solids are routed by a conveying gas stream into a mixing chamber where they meet a liquid jet of a PUR reaction mixture. It is preferable to let gas streams with solids meet in the mixing chamber by the gas streams entering the mixing chamber via two or more points and more preferably being opposite each other. The gas streams can also be routed in tangentially. In the process of the present invention, the particles cannot evade or escape from each other, since they are prevented from doing so by the walls of the mixing chamber. Therefore, in the process of the present invention, solids become losslessly force-wetted with the PUR reaction mixture in the interior of the mixing chamber and become part of a homogeneous gas/solid material/PUR material mixture.

It is preferable for the mixing quality of the resulting gas/solid material/PUR material mixture to be enhanced in the mixing chamber by additional air eddies. The air eddies are generated by tangential air nozzles and the circular areas they enclose are at a right angle to the axis of the main flow direction in the mixing chamber.

The solids-containing gas stream is preferably produced by directing a gas stream over solids-containing metering cells of a cellular wheel metering device. The compressed air stream flowing over the cell spaces entrains the solid material and transports it as a solid/air or gas mixture into the mixing chamber/head. To avoid pulsation, the channel in the interior of the metering device should be designed in terms of diameter such that positive overlap can be ruled out. This embodiment further ensures that even when the cellular wheel metering is switched off or changed in terms of rotary speed, a quantitatively unchanged air throughput for spraying the PUR reaction mixture is available and it is thus possible to spray selectively with or without variable quantities of solid material.

Presenting the solid materials free of differential pressure presents any compacting of the solids on entry into the gas stream.

The pressure equalization further prevents subsidiary streams of the transportation air escaping back into the stock reservoir container via the metering assembly (metering cells and gap tolerances). Relatively large gap dimensions are an inevitable consequence of the design in the case of abrasive solids in particular.

In both dense stream and flight conveyance, the maximum possible volume ratio of gas to solids on entry into the spraying-mixing nozzle is preferably in the range from 20:1 to 200:1 and more preferably in the range from 50:1 to 100:1.

This can be achieved by changing the solids feed rate for example.

It is further preferable to use nitrogen or especially air as gas. These gases are particularly inexpensive and thus contribute to a corresponding cost reduction afforded by the process of the present invention.

The examples which follow provide more particular elucidation of the invention.

### EXAMPLES

Only the mass layers (M) were produced for the tests and the measurements.

The polyol component and the isocyanate component were first dynamically mixed in the mixing head (mixing chamber), then the solids/gas stream was introduced into the reaction mixture, the mixture of polyurethane reaction mixture, solids and gas was aftermixed in an air eddy and subsequently spray dispensed via a spray nozzle.

Test 1 was carried out as described, except that unlike the other tests no stream of solids/gas was passed into the mixing chamber.

TABLE 1
Deployed polyurethane reactive mixtures and fillers

| | | Tests | | | |
|---|---|---|---|---|---|
| | Components | 1** | 2 | 3 | 4 |
| Polyol formulation | polyether 1 | 84.45 | 84.45 | 84.45 | 84.45 |
| | polyether 2 | 4 | 4 | 4 | 4 |
| | polyether 3 | 3.5 | 3.5 | 3.5 | 3.5 |
| | chain extender | 0.9 | 0.9 | 0.9 | 0.9 |
| | crosslinker 1 | 0.5 | 0.5 | 0.5 | 0.5 |
| | crosslinker 2 | 0.4 | 0.4 | 0.4 | 0.4 |
| | WATER | 3.8 | (3.8)* | (3.8)* | 3.8 |
| | color paste | 0.5 | 0.5 | 0.5 | 0.5 |
| | Stabilizer | 0.45 | 0.45 | 0.45 | 0.45 |
| | catalyst 1 | 0.65 | 0.65 | 0.65 | 0.65 |
| | catalyst 2 | 0.55 | 0.55 | 0.55 | 0.55 |
| | catalyst 3 | 0.3 | 0.3 | 0.3 | 0.3 |
| | total mass of polyol formulation in parts by | 100 | 96.2 | 96.2 | 100 |
| | weight | | | | |
| | POLYOL OH NUMBER | 296.6 | 62.3 | 62.3 | 296.6 |
| Isocyanate | isocyanate in parts by weight | 69.17 | 13.97 | 13.97 | 69.17 |
| | weight percent of isocyanate groups in | 32.1 | 32.1 | 32.1 | 32.1 |
| | isocyanate | | | | |
| | parts by weight of isocyanate per | 69.17 | 14.5 | 14.5 | 69.17 |
| | 100 parts by weight of unfilled polyol | | | | |
| | formulation | | | | |
| | isocyanate index | 100 | 100 | 100 | 100 |
| Drier | BAYLITH ® L POWDER | | 20 | 24 | |
| | (in weight percent based on PUR) | | | | |
| Filler | BARYTMEHL C901 | | | 24 | 28 |
| | (in weight percent based on PUR) | | | | |

**Comparator
The asterisked water * was not included in the calculation of the mass ratio in which the polyol and the isocyanate are mixed, since it is quantitatively absorbed by the drier and in its absorbed form does not react with isocyanate to form carbon dioxide.

Description of Starting Materials:
polyol 1: a commercially available trifunctional propylene oxide/ethylene oxide polyether with 14% by weight ethylene oxide content, on average 88% primary OH groups and an OH number of 28.
polyol 2: a commercially available difunctional propylene oxide polyether with an OH number of 56.
polyol 3: a commercially available trifunctional propylene oxide/ethylene oxide polyether with 71% by weight ethylene oxide content, on average 83% primary OH groups and an OH number of 37.
chain lengthener: 1,4-butanediol
crosslinker 1: glycerol
crosslinker 2: triethanolamine
color paste: Isopur Schwarzpaste N black, carbon black-polyol blend from ISL Chemie GmbH & Co. KG
stabilizer: Tegostab B4690 from Evonik Goldschmidt GmbH, polysiloxane-polyether copolymer
catalyst 1: Polycat 15 from Air Products, tetramethyliminobis(propylamine)
catalyst 2: Jeffcat DPA from Huntsman, N-(3-dimethylaminopropyl)-N,N-diisopropanolamine catalyst 3: DABCO NE1060 from Air Products, 3-(dimethylamino)propylurea
Baylith® L powder: sodium-potassium-calcium-A zeolite with pore size about 3 Å from UOP M.S. S.r.l.
Barytmehl C901: Barium sulfate with particle size distribution from 5 to 80 μm
Polyisocyanate: an isocyanate with NCO content about 32.1%, prepared from 2-ring MDI (methylenediphenylene diisocyanate) and its higher homologs

TABLE 2
Experimental data

| | Test | | | |
|---|---|---|---|---|
| | 1** | 2 | 3 | 4 |
| density of PUR spray layer [kg/m³] | 36.7 | 938 | 1310 | 122 |
| proportion of substance (A) and (B) | — | 20 | 48.3 | 27.6 |
| [% by weight] after ashing of polymer | | | | |
| fraction | | | | |
| thickness of PUR spray layer [mm] | 50 | 3.3 | 4.6 | 37.5 |

**Comparator

1. A method for producing a molded flexible polyurethane foam comprising a layer of massive polyurethane comprising solid particles and a second layer of foamed polyurethane, characterized in that
a) one or more gas streams containing solid particles are introduced into a liquid jet of a polyurethane reactive mixture in a mixing chamber,
b) the spray jet from a), which contains solid particles, is sprayed into a first half of an open mold comprising two mold halves,
c) the open mold is closed by means of a second mold half,
d) after full reaction of the polyurethane reactive mixture a second liquid spray jet of the same polyurethane reactive mixture is injected into the closed mold without the solid particles,
e) after full reaction of the second polyurethane reactive mixture the mold is opened and the molding is removed from the mold.

2. The method according to claim 1, characterized in that the polyurethane reactive mixture used under step a) and under step d) has the same composition and comprises the following components:
i) an organic isocyanate component, and
ii) a polyol component.

3. The method according to claim 1, characterized in that the solid particles are
A) a first solid substance having a high density of ≧2000 kg/m³ as filler,
B) a second solid substance as drier, and optionally
C) a third solid substance as defoaming agent.

4. The method according to claim 1, characterized in that the solid particles are
A) a first solid substance having a high density of ≧2000 kg/m³ as filler, which is optionally wetted with a defoaming agent, and
B) a second solid substance as drier, which is optionally wetted with a defoaming agent.

5. The method according to claim 1, characterized in that a defoaming agent is directed into the mixing chamber in addition to the polyurethane reactive mixture.

6. The method according to claim 1, characterized in that the gas stream containing solid particles contains the particles in a volume ratio of gas to solid substance in the range from 20:1 to 200:1.

7. The method according to claim 3, characterized in that the solid particles of the filler (A) have a diameter in the range from 4 μm to 5 mm, preferably in the range from 40 μm to 2 mm and more preferably 100 μm and 1000 μm.

8. The method according to claim 3, characterized in that the drier (B) is metered in a proportion of 0.5 to 50 weight percent in relation to the polyurethane reactive mixture, preferably in a proportion of 2 to 40 weight percent and more preferably in a proportion of 10 to 30 weight percent.
